(19) United States
(12) Patent Application Publication
(10) Pub. No.: US 2007/0124325 A1
(43) Pub. Date: May 31, 2007

(54) Systems and methods for organizing media based on associated metadata

(76) Inventors: Michael R. Moore, Folsom, CA (US); Daniel A. Kaye, Folsom, CA (US); Kenneth A. Turcotte, Folsom, CA (US); Randy J. Jongens, Folsom, CA (US); Michael D. Wang-Helmke, Carmichael, CA (US); Peter A. Tjeerdsma, Fair Oaks, CA (US); Christopher H. Davey, Sacramento, CA (US)

Correspondence Address: CARR & FERRELL LLP, 2200 GENG ROAD, PALO ALTO, CA, 94303, US

(21) Appl. No.: 11/517,823

(22) Filed: Sep. 7, 2006

Related U.S. Application Data
(60) Provisional application No. 60/715,002, filed on Sep. 7, 2005.

(51) Int. Cl. G06F 7/00

(52) U.S. Cl. 707/102

(57) ABSTRACT

A system and method for organizing media based on associated metadata is provided. One or more items of media are accessed. Metadata associated with the one or more items of media is identified. A grouping for the one or more items of media according to the metadata is determined. The one or more items of media are organized according to the grouping.

### CROSS-REFERENCE TO RELATED APPLICATIONS

The present application claims the benefit and priority of U.S. provisional patent application Ser. No. 60/715,002 filed on Sep. 7, 2005 and entitled “Dynamic Content Authoring Based on Associated Metadata,” which is herein incorporated by reference.

### BACKGROUND OF THE INVENTION

1. Field of the Invention

The present invention relates generally to media organization, and more particularly to systems and methods for organizing media based on associated metadata.

1. Description of Related Art

Conventionally, photos, documents, and other media are organized manually, such as in a photo album. With the popularity of digital media, various digital media organizational tools are available. For example, a digital photo album may be utilized to order digital photos. A user selects an order for the digital photos and the digital photos are arranged in the selected order, in the digital photo album.

Another organizational tool for media includes DVDs. Digital media may be stored on DVDs. Images may be organized on the DVD in an order and played according to the order. Unfortunately, the user is required to specify the order for each of the images, documents, photos, and so forth. For example, if the user wants to group the images from a camping trip and order the images from the beginning of the camping trip to the end of the camping trip, the user may need to specify which images are associated with the camping trip and which images relate to the beginning, a middle, and the end of the camping trip. Some digital devices, such as digital cameras, are capable of transferring digital images, according to the order captured, to a computer, for example. However, the user often must rearrange the digital images if the user wishes to arrange the digital images according to a different order from when each of the digital images is captured.

### SUMMARY OF THE INVENTION

The present invention provides a system and method for organizing media based on associated metadata. One or more items of media are accessed. Metadata associated with the one or more items of media is identified. A grouping for the one or more items of media according to the metadata is determined. The one or more items of media are organized and presented according to the grouping.

### BRIEF DESCRIPTION OF THE DRAWINGS

FIG. 1 illustrates an exemplary environment for organizing media based on associated metadata;

FIG. 2 illustrates a block diagram of an exemplary media engine;

FIG. 3 illustrates how exemplary images may be grouped according to time;

FIG. 4 illustrates a flow diagram of an exemplary process for organizing media based on associated metadata; and

FIG. 5 illustrates a flow diagram of an exemplary process for presenting media according to an output selection.

### DETAILED DESCRIPTION

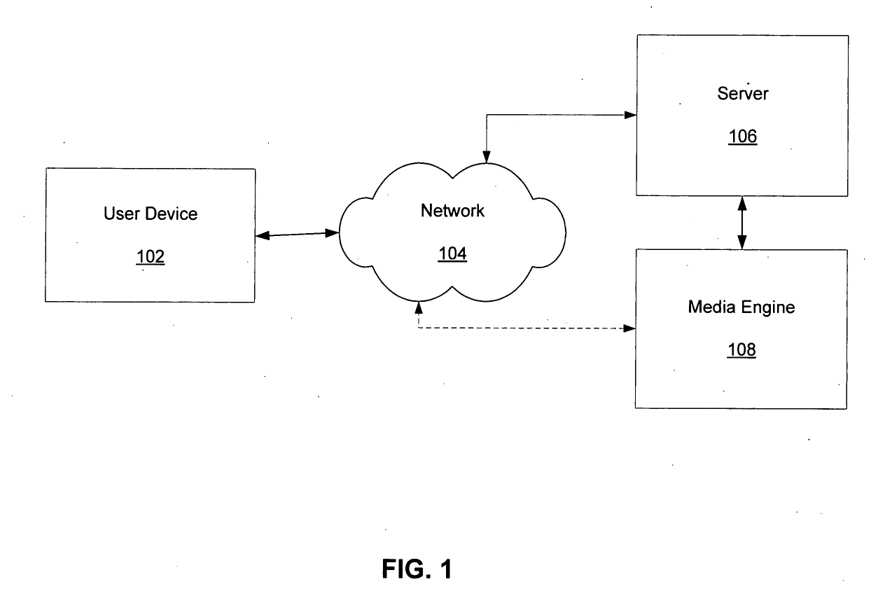

FIG. 1 illustrates an exemplary environment for organizing media based on associated metadata. A user device 102 communicates with a server 106 via a network 104. The user device 102 may comprise more than one user devices according to exemplary embodiments. The user device 102 may comprise a laptop computer, a desktop computer, a personal digital assistant, a cellular telephone, a digital camera, and so forth. Any type of user device 102 capable of generating, storing, and or providing digital media is within the scope of various embodiments.

A media engine 108 is coupled to the server 106. The media engine 108 organizes various media, such as digital media, from the user device 102 and/or from the server 106 based on associated metadata. According to some embodiments, the user device 102 may directly communicate with the media engine 108 via the network 104. In still further embodiments, the media engine 108 may comprise a standalone software application installed on the user device 102.

The user device 102 and/or the server 106 may include, create, and/or access various types of digital media, such as digital images, video, music, and documents. The digital media may have various metadata associated with the digital media. For example, metadata may include information associated with face recognition, image recognition, image resolution, color, texture, sound, shape, time, time and date stamp, capture device, camera settings, keywords, author identity, subject matter, and so forth. Any type of metadata may be associated with the digital media. As another example, metadata such as beat data, tempo data, tags associated with a popular musical selection, and so forth may be associated with digital media comprising music.

The media engine 108 can access the digital media from the user device 102, from the server 106, or from any other third party source. For example, the server 106 can access media via the Internet for the media engine 108. The media engine 108 identifies the metadata associated with the digital media and organizes the digital media according to the associated metadata. Any of the metadata may be utilized for organizing the digital media. According to exemplary embodiments, the metadata may be grouped according to categories, which are in turn utilized for organizing the digital media.

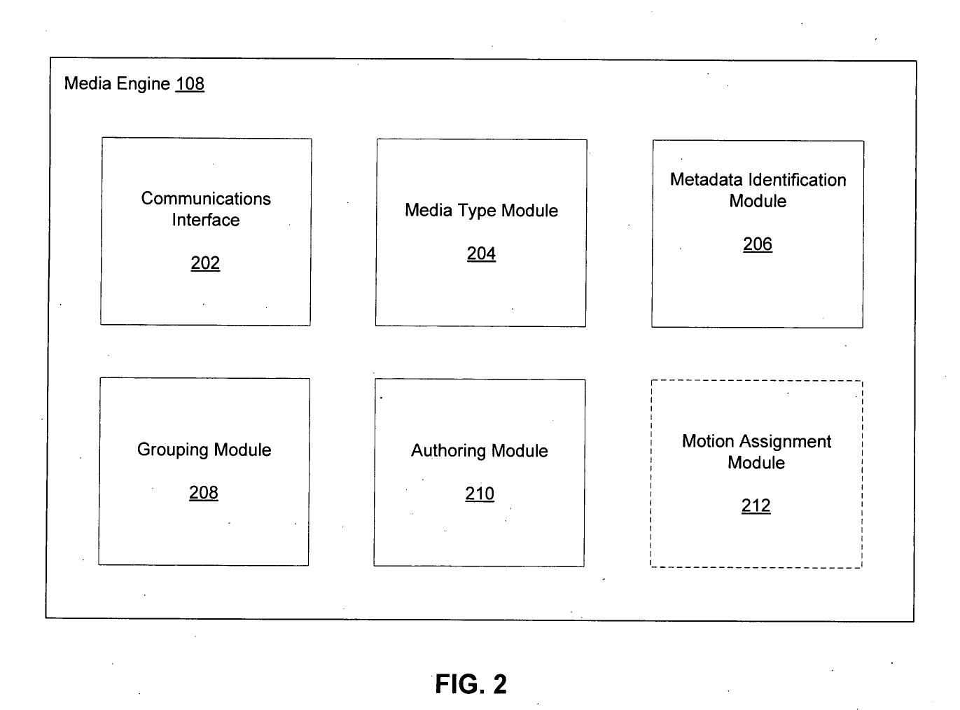

Referring now to FIG. 2, a block diagram of an exemplary media engine, such as the media engine 108 discussed in FIG. 1, is illustrated. A communications interface 202 is provided for communicating data between the server 106 and the media engine 108. Any type of data, such as the digital media and the associated metadata may be communicated between the server 106 and the media engine 108, between the server 106 and the user device 102 via the network 104, and so forth.

A media type module 204 is provided for determining the type of the digital media, i.e., the digital media may comprise documents, images, music, and so forth. By determining the type of the digital media, the digital media can be organized according to the type and/or any other desired information, such as the associated metadata, as discussed herein.

A metadata identification module 206 identifies the metadata associated with the digital media. As discussed herein, the metadata may comprise the time an image is captured, type of camera, keywords, date last modified, and so forth. The metadata is typically automatically associated with the digital media when the digital media is generated. However, the metadata associated with the digital media may be assigned to the digital media by a third party after the digital media is generated or by the user device 102 or the media engine 108 according to some embodiments. Any type of process for associating the metadata with the digital media is within the scope of various embodiments.

A grouping module 208 is provided for grouping the digital media. The digital media may be grouped according to the associated metadata, the type of media, or other selected parameters. For example, the digital media may be grouped according to the subject matter identified by the metadata identification module. 108. In one instance, the digital media may be grouped according to a common family member pictured in one or more images. The grouping may also comprise related images, for example, the images are grouped according to time, time and date, music, subject matter, author, and so forth. Thus, for example, the images may be grouped according to a song that plays when the particular clustered images are displayed. Any type of grouping may be employed.

An authoring module 210 is provided for selecting the digital media and/or ordering the digital media, for presentation or display. For example, the authoring module 210 may utilize groups assigned to a cluster of digital media from the grouping module 208 and generate transitions between the groups, build a rule set for the types of transitions to utilize between groups, arrange the groups for presentation, determine which groups should be displayed, assign a theme to the group, and so forth.

A motion assignment module 212 is optionally provided for assigning motions to digital media comprising images. The motion assignment module 212 can automatically assign photo motions from a repeating list of preset motions. For example, the images can move from left to right, zoom in or zoom out, move up or down, and so forth. Any type of motion may be assigned to the images by the motion assignment module 212. Further, the motions may be assigned based on a theme, music, a portrait or landscape aspect associated with the images, and so forth. Sequences of the motions can then be preset according to the theme, chosen by music, or affected by the portrait or landscape aspect associated with the images. The photo motions may comprise transitions between groupings, according to some embodiments.

Although various modules are shown in associated with the exemplary media engine 108 in FIG. 2, fewer or more modules may comprise the media engine 108 and still fall within the scope of various embodiments. For example, a media locator module (not shown) may be provided for searching the user device 102, the server 106, or any other source for the digital media.

A user interface (not shown) may be provided via the server 106 or the media engine 108 for receiving input from a user, such as an indication of the digital media the user wants to include in a grouping.

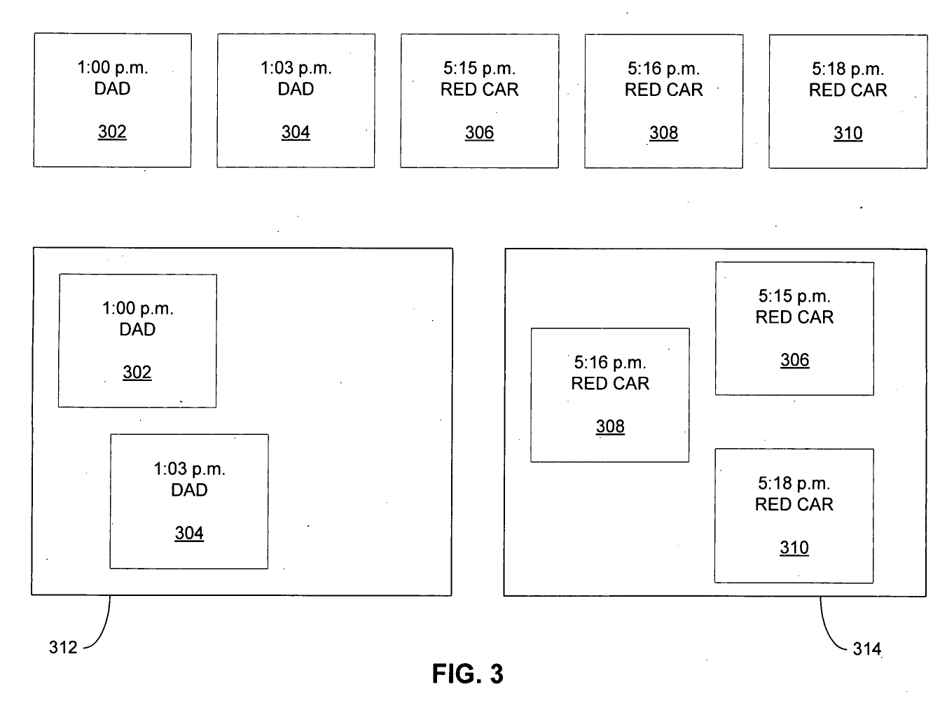

FIG. 3 illustrates a schematic diagram of exemplary image groupings according to time. Various digital media comprising images are displayed in FIG. 3 at various times. For example, an image entitled or labeled “Dad” at 1:00 p.m. 302 was captured, a second image labeled “Dad” at 1:03 p.m. 304 was captured, an image labeled “Red Car” at 5:15 p.m. 306 was captured, a second image labeled “Red Car” at 5:16 p.m. 308 was captured, and a third image labeled “Red Car” at 5:18 p.m. 310 was captured. The media engine 108 can automatically group the images labeled “Dad” together based on the proximity of time when the images entitled “Dad” were captured. The labels and the times of the images comprise metadata. Although labels and times are shown in FIG. 3 as associated metadata, more or less metadata may be associated with the images.

A first grouping 312 organizes the images labeled “Dad”, such as the image labeled “Dad” at 1:00 p.m. 302 and the image labeled “Dad” at 1:03 p.m. 304. Each of the images labeled “Dad” may be organized in order according to the time, or in any other order.

A second grouping 314 organizes the images labeled “Red Car.” The images may be grouped according to the subject matter, such as “Dad” and “Red Car”, or according to any other metadata. The metadata may be utilized to display the images according to the subject matter and/or time, such as the first grouping 312 and the second grouping 314 shown in FIG. 3. Any groupings may be assigned to the digital media by the grouping module 208.

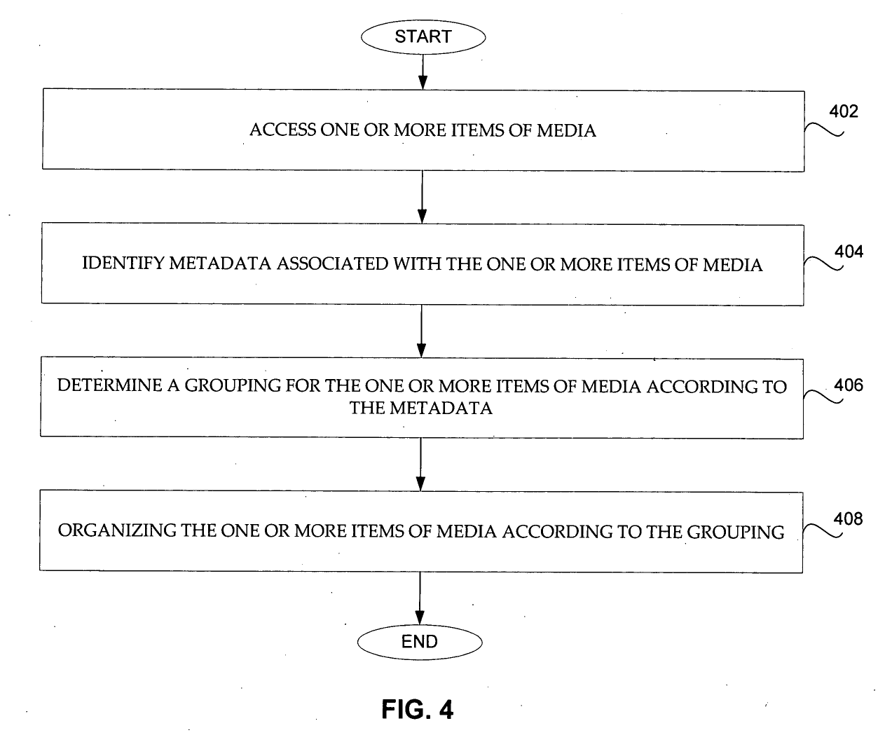

FIG. 4 shows a flow diagram of an exemplary process for organizing media based on associated metadata. At step 402, a plurality of media is accessed. For example, the media engine 108 may access one or more items of the digital media from the server 106, the user device 102, or from any other source. As discussed herein, the digital media may include digital images, video, music, documents, and so forth.

At step 404, metadata associated with the plurality of media is identified. For example, the metadata identification module 206 can identify the metadata. The metadata may be associated with the digital media when the digital media is created. In alternative embodiments, the metadata is associated with the digital media after the digital media is created. For example, the media engine 108 or the user device 102 can assign metadata to the digital media after the digital media is generated.

As discussed herein, the metadata can include any type of information associated with the digital media, such as a timestamp, face recognition, image recognition, image resolution, color, texture, sound, shape, the type of camera or other device used to capture the digital media, camera settings associated with the digital media, keywords, document creation date, document modification date, author identity, subject, beat data, tempo data, tags, genre, and so forth. Any of the metadata can be utilized to automatically select and organize the digital media for presentation. One or more items of metadata may be associated with each item of digital media, for example.

At step 406, at least one grouping is determined for the plurality of media according to the metadata. As discussed herein, any of the metadata may be utilized to determine the grouping. For example, the timestamps and the subject matter, as exemplified in FIG. 3, may be considered in determining the grouping or only images with similar landscapes may be considered to determine the grouping. The same digital media or group of digital media may be assigned more than one grouping, according to exemplary embodiments. For example, the digital media may be assigned to a group according to subject matter and at the same time to another group according to the author.

At step 408, the plurality of media is organized according to the at least one grouping. For example, the one or more items of media may be ordered for presentation according to a timestamp grouping or a common music artist. As discussed herein, any type of organization may be utilized to organize the digital media according to the grouping. Organizing the digital media may comprise editing the digital media within the grouping for presentation, generating transitions between groupings for presentation, generating transitions between the digital media within the grouping, and so forth.

According to some embodiments, organizing the digital media includes assigning digital effects to the grouping, assigning a song to play when the grouping is presented, assigning visual effects to the beginning and end of the grouping, and so forth. The digital media may be automatically organized according to the metadata and the groupings, according to exemplary embodiments. For example, documents with the same keywords, images with the same subject matter, or songs by a particular artist may be utilized to automatically organize the digital media according to the metadata associated with the digital media.

The groupings can also be determined automatically. For example, a time gap between various images may be utilized to subdivide the various images according to the gap. The various images may continue to be subdivided until there are no gaps larger than a predetermined threshold, for instance.

Images or documents, for example, may be grouped together automatically according to timestamps. If pictures or documents are taken or generated, respectively, within a time threshold of one another (e.g., five minutes), the pictures or the documents may be grouped together. Each picture or document taken or generated within the threshold is also added to the grouping. The pictures in the grouping, for example, may receive a complementary set of visual effects on a DVD, or be placed on one or more sets of neighboring pages in a printed photo book. According to other embodiments, the digital media may be grouped according to metadata that indicates the digital media's location in memory, directories, databases, and so forth. For example, the digital media may be automatically grouped according to a file tree.

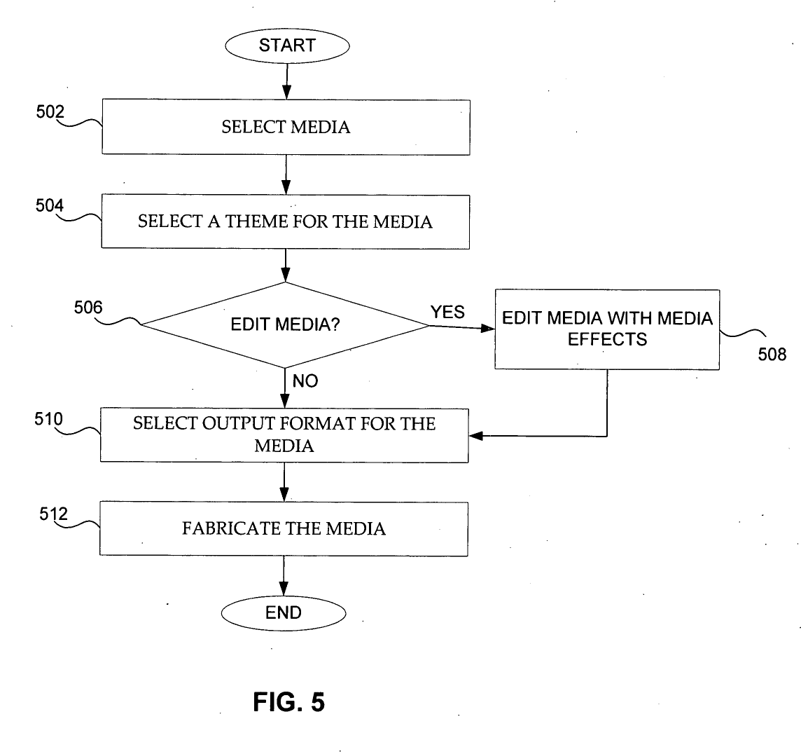

Referring now to FIG. 5, a flow diagram of an exemplary process for presenting media according to an output selection is shown. At step 502, media is selected. For example, a user at the user device 102 can select one or more items of the digital media. Any type of digital media may be selected, such as images, songs, documents, and so forth.

At step 504, a theme for the media is selected. For example, the user may select “family vacation” for the media. The theme may be provided by the user or selected from a predetermined menu of themes. Themes may include, for example, graphic elements, such as backgrounds, vignettes, “clip art”, color sets, text styles, fonts, and so forth, or information about where the digital media fits in a theme. Any type of theme may be selected or provided by the user or any other source. The motion assignment module 212 can automatically assign motions to the digital media according to the theme. Further, the digital media can be grouped, automatically or otherwise, according to the theme.

At step 506, the user is queried as to whether or not the user wants to edit the media. For example, the server 106 can query the user about media editing. Various types of editing may be utilized, such as adding or removing the digital media comprising the groupings, as discussed herein, adding transitions between the groupings, and so forth.

At step 508, the media is edited with media effects, such as transitions, music accompaniments, and so forth, as discussed herein. At step 510, the user selects an output format for the media. The output format may be selected from a menu or specified in any other manner. The user may choose any type of output format for the media, such as PowerPoint Presentation, DVD, computer slideshow, printed photo book, printed calendar and so forth.

At step 510, the media is presented according to the selections from the user, such as the output format, the edits to the media, and the theme for the media. Presentation of the media may include transforming the media originally created in DVD format to a Photo Book, for example. Instances of presentation include, but are not limited to, DVD movie, a printed photo book, an Internet slide show, and a coffee mug. Any type of presentation of the digital media may be employed. Presentation may also include organizing the media according to the metadata and the grouping, as discussed in FIG. 4.

According to some embodiments, the metadata may be utilized to indicate a music genre, a music preference, or other aspects of a musical selection, for example. The music genre can comprise a particular grouping or the music genre may be associated with an established grouping, such as a grouping by musical artist. As discussed herein, grouping the metadata may be utilized to keep the digital media together according to the grouping, such as songs by a particular artist, pictures captured at or near the same time or pictures of the same person or subject matter. The metadata can be automatically identified and utilized by the authoring module 210 to determine the grouping that will be presented and the manner or organization of presentation of the grouping.

According to some embodiments, the authoring module 210 generates one or more sets of rules for automatically identifying and/or grouping the metadata associated with the digital media. For example, a set of rules that organizes the digital media according to timestamps and a set of rules that organizes the digital media according to keywords may be generated. Either of the set of rules may be utilized to organize the digital media. According to some embodiments, the user is queried about potential organizational schemes in order for the authoring module 210 to determine which of the sets of rules to employ.

According to exemplary embodiments, image processing techniques, such as face recognition, image recognition, color, texture, shape matching, information associated with an image at the time the image is captured, camera type, camera settings, and so forth may be utilized for grouping the digital media that comprises one or more images. As discussed herein, one or more of the image processing techniques, or other types of metadata, may be utilized to determine the grouping and/or to organize the digital media.

The digital media may be automatically organized according to the metadata and the grouping, as discussed herein. A user may then be queried to determine whether the automatic organization is acceptable to the user. The user may also be presented with options for modifying the organization. For example, one or more images may be organized according to a particular family member, such as pictures of a brother are grouped together. The user may choose to group the pictures according to timestamps, instead. Any type of modification to the organization of the digital media, by the user or by the media engine 108, is within the scope of various embodiments.

While various embodiments have been described above, it should be understood that they have been presented by way of example only, and not limitation. For example, any of the elements associated with the media engine 108 may employ any of the desired functionality set forth hereinabove. Thus, the breadth and scope of a preferred embodiment should not be limited by any of the above-described exemplary embodiments.

What is claimed is:

1. A method for organizing media based on associated metadata, comprising:
accessing a plurality of media;
identifying metadata associated with the plurality of media;
determining at least one grouping for the plurality of media according to the metadata; and
organizing the plurality of media according to the at least one grouping.

2. The method recited in claim 1, wherein the plurality of media includes at least one image.

3. The method recited in claim 1, wherein the plurality of media includes at least one video.

4. The method recited in claim 1, wherein the plurality of media includes at least one document.

5. The method recited in claim 1, wherein the metadata includes a time stamp associated with at least one of the plurality of media.

6. The method recited in claim 1, wherein the metadata includes an indication of subject matter of at least one of the plurality of media.

7. The method recited in claim 1, wherein the organizing comprises editing the grouping.

8. The method recited in claim 1, wherein the organizing comprises assigning transitions to the at least one grouping.

9. A system for organizing media based on associated metadata, comprising:
a user device configured to access plurality of media;
a metadata identification module in communication with the user device interface, the metadata identification module configured to identify metadata associated with the plurality of media;
a grouping module, in communication with the metadata identification module, the grouping module configured to determine at least one grouping for the plurality of media according to the metadata; and
an authoring module, in communication with the grouping module, the authoring module configured to organize the plurality of media according to the at least one grouping.

10. The system recited in claim 9, wherein the plurality of media includes at least one image.

11. The system recited in claim 9, wherein the plurality of media includes at least one video.

12. The system recited in claim 9, wherein the plurality of media includes at least one document.

13. The system recited in claim 9, wherein the metadata includes a time stamp associated with at least one of the plurality of media.

14. The system recited in claim 9, wherein the metadata includes an indication of subject matter of at least one of the plurality of media.

15. The system recited in claim 9, wherein the authoring module is further configured to edit the grouping.

16. The system recited in claim 9, wherein the authoring module is further configured to assign transitions to the at least one grouping.

17. A computer program embodied on a computer readable medium for organizing media based on associated metadata, having instructions comprising:
accessing plurality of media;
identifying metadata associated with the plurality of media;
determining at least one grouping for the plurality of media according to the metadata; and
organizing the plurality of media according to the at least one grouping.

18. The computer program recited in claim 17, wherein the plurality of media includes at least one image.

19. The computer program recited in claim 17, wherein the plurality of media includes at least one video.

20. The computer program recited in claim 17, wherein the plurality of media includes at least one document.

21. The computer program recited in claim 17, wherein the metadata includes a time stamp associated with at least one of the plurality of media.

22. The computer program recited in claim 17, wherein the metadata includes an indication of subject matter of at least one of the plurality of media.

23. The computer program recited in claim 17, wherein the organizing comprises editing the grouping.

24. The computer program recited in claim 17, wherein the organizing comprises assigning transitions to the at least one grouping.
